(19) United States
(12) Patent Application Publication
(10) Pub. No.: US 2008/0171236 A1
(43) Pub. Date: Jul. 17, 2008

(54) Fuel battery

(76) Inventor: Chien-Hung Lin, Taoyuan County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/797,370

(22) Filed: May 3, 2007

(30) Foreign Application Priority Data
Jan. 16, 2007 (TW) 96200841

(51) Int. Cl. H01M 8/02

(52) U.S. Cl. 429/12

(57) ABSTRACT

A fuel battery including an electrically conductive inner body, a membrane electrode set and an electrically conductive outer body is disclosed. The electrically conductive inner body has an accommodating space, and has an opening communicating with the accommodating space. The electrically conductive inner space has a plurality of through holes penetrating through the entire electrically conductive inner body. The membrane electrode set covers the outer surface of the electrically conductive inner body. The electrically conductive outer body covers the outer surface of the membrane electrode set. The electrically conductive outer body has a plurality of second through holes penetrating through the entire electrically conductive outer body.

### BACKGROUND OF THE INVENTION

1. Field of the Present Invention

The present invention generally relates to an improved structure for a fuel battery, and more particularly to an improved structure for a direct methanol fuel battery.

2. Description of the Related Art

Energy is a critical factor to basic economic development. Petroleum, natural gas and coal are heavily used throughout the world as main energy sources while nuclear energy is often used as a secondary energy source. These energy sources have been shown to pose considerable risks and serious pollution to our living environment. Furthermore, industry analysts predict increasing shortages due to huge increases in consumption as demand from the developing world grows. Fuel batteries have drawn intensive attention in the search for new energy alternatives because of their superior advantages such as high availability, high power efficiency, wide scope of application and low pollution.

In a conventional fuel battery, a flow guiding plate is mounted on each side of a membrane electrode assembly (MEA) for fuel and gas to flow to the membrane electrode set for reaction. TW Patent No. 292791, published on Jun. 21, 2006, discloses a flow guiding plate for a fuel battery. However, the above conventional fuel battery has a complex structure with a high manufacturing cost. This disadvantage adversely affects the benefits and thus blocks the fuel battery from being brought into general or common use.

Therefore, there is a need for a fuel battery which overcomes the above disadvantages.

### SUMMARY OF THE INVENTION

It is an object of the present invention to provide a fuel battery with a simplified construction and reduced manufacturing cost.

It is another object of the present invention to provide a fuel battery that can be applied to an active or passive power system as required.

In order to achieve the above or other objectives, the fuel battery of the present invention includes

an electrical conductive inner body, having an accommodation space inside and an opening communicating with the accommodation space, wherein the electrically conductive inner body has a plurality of first through holes penetrating through the entire electrical conductive inner body.

a membrane electrode set, covering an outer surface of the electrically conductive inner body; and

an electrically conductive outer body, covering an outer surface of the membrane electrode set, wherein the electrically conductive outer body has a plurality of second through holes penetrating through the entire electrically conductive outer body.

To provide a further understanding of the present invention, the following detailed description illustrates embodiments and examples of the present invention, this detailed description being provided only for illustration of the present invention.

### BRIEF DESCRIPTION OF THE DRAWINGS

FIG. 1 is an exploded view of a fuel battery according to one embodiment of the present invention;

FIG. 1A is a schematic view of second through holes of an electrically conductive outer body according to one embodiment of the present invention;

FIG. 2 is a cross-sectional view of an electrically conductive inner body according to one embodiment of the present invention; and

FIG. 3 is an assembly view of a fuel battery according to one embodiment of the present invention.

### DETAILED DESCRIPTION OF THE PREFERRED EMBODIMENTS

Wherever possible in the following description, like reference numerals will refer to like elements and parts unless otherwise illustrated.

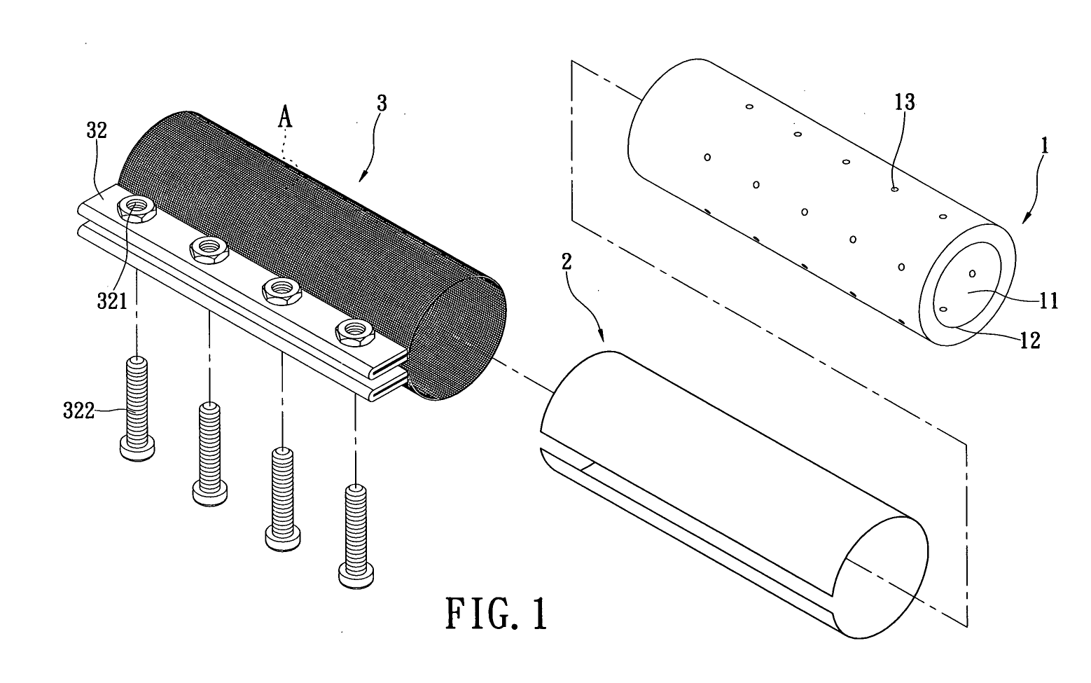

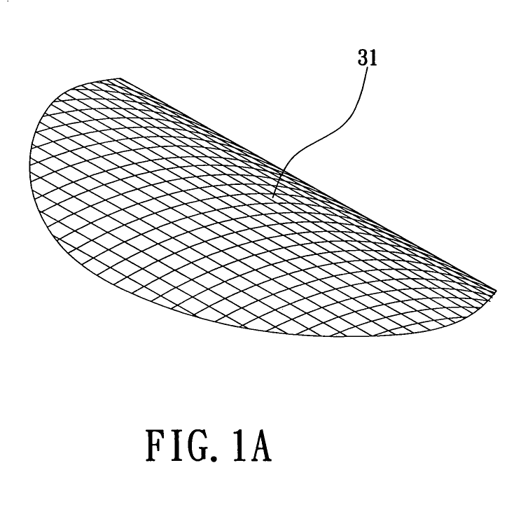

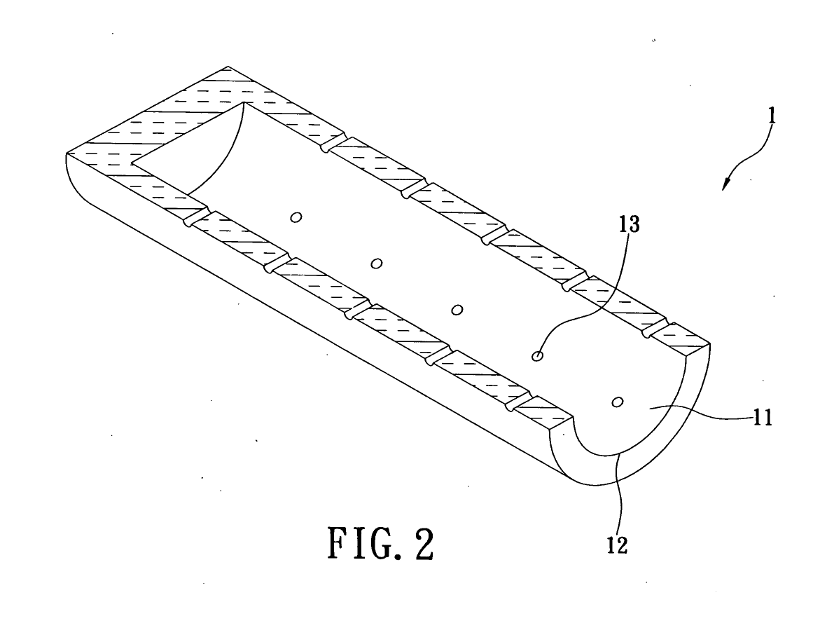

Referring to FIG. 1, FIG. 1A and FIG. 2, the fuel battery according to the present invention includes an electrical conductive inner body 1, a membrane electrode set 2, and an electrically conductive outer body 3.

The electrically conductive inner body 1 is a hollow cylinder made of electrical conductive material, or is obtained by inserting an electrical conductive hollow sleeve between a cylindrical assembly of a plurality of rubber elements (not shown). The electrical conductive material can be metal or graphite. The electrical conductive inner body 1 has an accommodation space 11 inside and an opening 12 communicating with the accommodation space 11 for being filled up with fuel, such as methanol. The electrical conductive inner body 1 has a plurality of first through holes 13 distributed at equal intervals. The first through holes 13 can be fine pinholes penetrating through the entire electrical conductive inner body 1 to form a fuel passage.

The membrane electrode set 2 can be a flexible sheet, which thoroughly or partially covers an outer surface of the electrical conductive inner body 1 and further covers the first through holes 13. The membrane electrode set 2 includes a proton exchanger membrane and a set of anode and cathode catalytic layers disposed oppositely on either side of the proton exchanger membrane.

The electrical conductive outer body 3 has a metallic net structure or a metallic plate, having a plurality of second through holes 31. The second through holes 31 penetrate through the entire electrically conductive outer body 3 to form a gas passage. The electrically conductive outer body 3 has a shape conforming to the membrane electrode set 2. Each opposite end of the electrically conductive outer body 3 has a connector 32 with a plurality of screw holes 321 respectively engaging with a plurality of screws 322. The method of connecting the two connectors 32 is not particularly limited and they can be either soldered or riveted together.

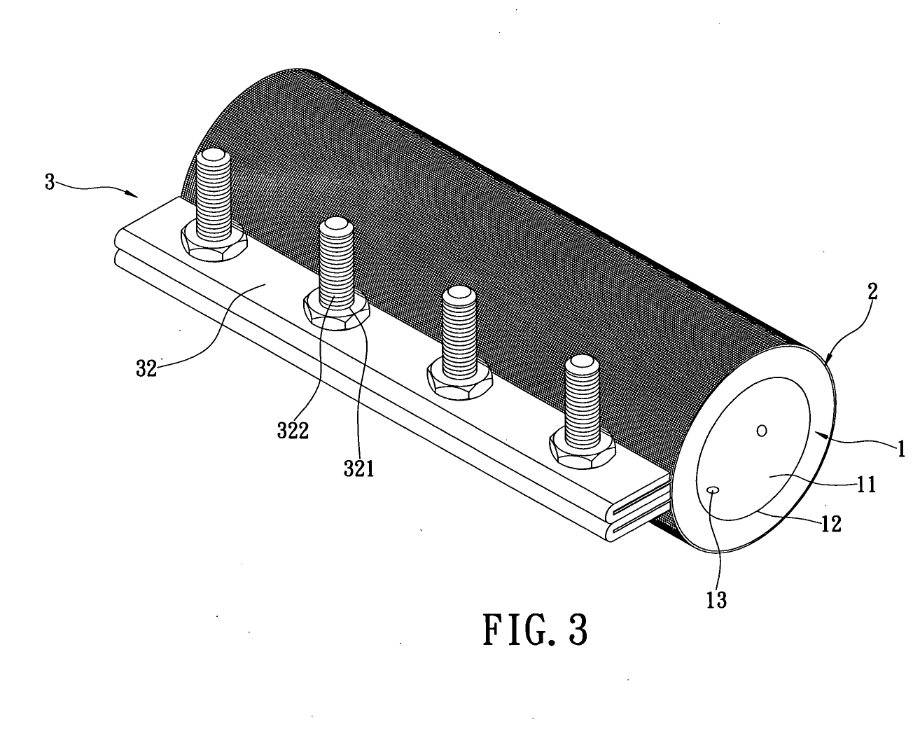

Referring to FIG. 3, the membrane electrode set 2 covers an outer surface of the electrically conductive inner body 1 and is located inside the electrically conductive outer body 3. The two connectors 32 are secured by the screws 322. Together, the membrane electrode set 2 and the electrical conductive inner body 1 are tightly bound to an interior of the electrical conductive outer body 3. The electrically conductive inner body 1 is used as an anode and the electrically conductive outer body 3 is used as a cathode. Methanol fuel fills up the accommodation space 11. The methanol and the air are converted into electric energy with the use of the membrane electrode set 2. Thereby, a direct methanol fuel cell (DMFC) is accomplished.

The opening 12 can be added with a flow-forcing device such as pump to force the fuel and the gas to flow through the first through holes 13 and the second through holes 31 to reach the membrane electrode set 2 for reacting. Thereby an active fuel battery is accomplished. The fuel is forced to flow through the first through holes 13 by the action of capillarity, gravity and diffusion in the electrically conductive inner body 1 to reach the membrane electrode set 2 and react. A passive fuel battery is thereby accomplished.

The present invention provides some advantages over the prior art. The construction of the electrically conductive inner body 1 and the electrically conductive outer body 3 is simple, so that the difficulty of processing is reduced and therefore the manufacturing costs are greatly reduced.

Furthermore, the fuel battery according to the present invention can be applied to an active or passive power system as required.

A malfunctioning battery can be quickly found and repaired because each fuel battery is independently installed. It is convenient to use the fuel battery, compared to the prior art.

It should be apparent to those skilled in the art that the above description is only illustrative of specific embodiments and examples of the present invention. The present invention should therefore cover various modifications and variations made to the herein-described structure and operations of the present invention, provided they fall within the scope of the present invention as defined in the following appended claims.

What is claimed is:

1. A fuel battery, comprising
an electrical conductive inner body, having an accommodation space inside and an opening communicating with the accommodation space, wherein the electrically conductive inner body has a plurality of first through holes penetrating through the entire electrical conductive inner body.
a membrane electrode set, covering an outer surface of the electrically conductive inner body; and
an electrically conductive outer body, covering an outer surface of the membrane electrode set, wherein the electrically conductive outer body has a plurality of second through holes penetrating through the entire electrically conductive outer body.

2. The fuel battery of claim 1, wherein the electrically conductive inner body is a hollow cylinder.

3. The fuel battery of claim 1, wherein the accommodation space is filled with fuel, and the first through hole is a fuel passage.

4. The fuel battery of claim 1, wherein the membrane electrode set has a proton exchanger membrane and a set of anode and cathode catalytic layers disposed oppositely on either side of the proton exchanger membrane.

5. The fuel battery of claim 1, wherein the electrically conductive outer body has two connectors located at opposite ends of the electrically conductive outer body and connected to each other.

6. The fuel battery of claim 1, wherein the second through holes are gas passages.

7. The fuel battery of claim 1, wherein the electrically conductive inner body is either integrally formed or formed as an assembly of a plurality of elements.

8. The fuel battery of claim 1, wherein the membrane electrode set thoroughly or partially covers the outer surface of the electrically conductive inner body.
